(19) United States
(12) Patent Application Publication
(10) Pub. No.: US 2025/0362679 A1
(43) Pub. Date: Nov. 27, 2025

(54) LEARNING SURFACE PROFILES WITH INERTIAL SENSORS AND NEURAL NETWORKS FOR IMPROVING NAVIGATION IN MOBILE MACHINES

(71) Applicant: Futronics (NA) Corporation, Pasadena, CA (US)

(72) Inventors: LUIS ALFREDO MATEOS GUZMAN, Pasadena, CA (US); Zhipeng Liu, Pasadena, CA (US); Wenda Xu, Pasadena, CA (US); Fangyun Zhao, Pasadena, CA (US); Chengkun Zhang, Pasadena, CA (US)

(21) Appl. No.: 18/674,966

(22) Filed: May 27, 2024

(51) Int. Cl. G05D 1/245; G05D 1/246; G05D 101/15; G06N 3/08

(52) U.S. Cl. CPC G05D 1/245; G05D 1/246; G06N 3/08; G05D 2101/15

(57) ABSTRACT

Mobile machine navigation according to surface profile is disclosed. A mobile machine is navigated on a surface by: receiving, from at least an accelerometer of the mobile machine, acceleration data of a determined window size while navigating the mobile machine on the surface; inputting the received acceleration data into an artificial neural network-based surface profile classifier; receiving a surface profile of the surface from the surface profile classifier; determining a navigation parameter corresponding to the surface profile; and navigating the mobile machine according to the determined navigation parameter.

### TECHNICAL FIELD

The present disclosure relates to navigation technology, and particularly to a navigation method and a mobile machine using the same.

### BACKGROUND

With the advance of artificial intelligence (AI), AI-based sensing-related technologies have allowed mobile robots to navigate indoors and outdoors accurately. It is common that mobile robots improve the reliability of navigation and the detection of obstacles by integrating sensing suites with multi-type sensors, because multi-modal sensing can complement different types of sensors to better understand the environment in which a mobile robot is located and compensate each other for their drawbacks. For example, optical sensors (e.g., cameras and infrared sensors) may fail to detect obstacles made of transparent materials such as glass or acrylic, while ultrasound sensors may be used to detect them. In addition, mobile robots use simultaneous localization and mapping (SLAM) to localize itself, create maps and navigate in known or unknown places.

Nevertheless, these sophisticated techniques for navigation do not consider the surface profile on which a robot is moved. For example, some mobile robots like service robot (e.g., cleaning robot) transporting items from room to room in a hospital, restaurant or the like are not actively detecting the type of floor on which it is moved, while their braking distances and acceleration profiles when moving on a slippery floor type will not be the same as that when moving on a carpet.

### BRIEF DESCRIPTION OF DRAWINGS

In order to more clearly illustrate the technical solutions in this embodiment, the drawings used in the embodiments or the description of the prior art will be briefly introduced below. In the drawing(s), like reference numerals designate corresponding parts throughout the figures. It should be understood that, the drawings in the following description are only examples of the present disclosure. For those skilled in the art, other drawings can be obtained based on these drawings without creative works.

FIG. 1 is a schematic diagram of a scenario of navigating a mobile machine across different floor types according to some embodiments of the present disclosure.

FIG. 2 is a schematic block diagram illustrating the mobile machine of FIG. 1.

FIG. 3 is a schematic block diagram of an example of navigating the mobile machine of FIG. 2.

FIG. 4 is a flow chart of an example of preprocessing acceleration data and training a surface profile classifier according to some embodiments of the present disclosure.

FIG. 5 is a schematic diagram of accelerations from moving over different surfaces according to some embodiments of the present disclosure.

FIG. 6 is a flow chart of an example of preprocessing the acceleration data in the example of FIG. 4.

FIG. 7 is a flow chart of an example of auto-tunning the surface profile classifier in the example of FIG. 4.

FIG. 8 is a schematic diagram of auto-tunning the surface profile classifier in the example of FIG. 4.

FIG. 9 is a flow chart of an example of retraining the surface profile classifier and receiving a surface profile according to some embodiments of the present disclosure. classifying surface profile.

FIG. 10 is a flow chart of an example of navigating the mobile machine of FIG. 2.

### DETAILED DESCRIPTION

In order to make the objects, features and advantages of the present disclosure more obvious and easy to understand, the technical solutions in this embodiment will be clearly and completely described below with reference to the drawings. Apparently, the described embodiments are part of the embodiments of the present disclosure, not all of the embodiments. All other embodiments obtained by those skilled in the art based on the embodiments of the present disclosure without creative efforts are within the scope of the present disclosure.

It is to be understood that, when used in the description and the appended claims of the present disclosure, the terms “including”, “comprising”, “having” and their variations indicate the presence of stated features, integers, steps, operations, elements and/or components, but do not preclude the presence or addition of one or a plurality of other features, integers, steps, operations, elements, components and/or combinations thereof.

It is also to be understood that, the terminology used in the description of the present disclosure is only for the purpose of describing particular embodiments and is not intended to limit the present disclosure. As used in the description and the appended claims of the present disclosure, the singular forms “one”, “a”, and “the” are intended to include the plural forms as well, unless the context clearly indicates otherwise.

It is also to be further understood that the term “and/or” used in the description and the appended claims of the present disclosure refers to any combination of one or more of the associated listed items and all possible combinations, and includes such combinations.

In the present disclosure, the terms “first”, “second”, and “third” are for descriptive purposes only, and are not to be comprehended as indicating or implying the relative importance or implicitly indicating the amount of technical features indicated. Thus, the feature limited by “first”, “second”, and “third” may include at least one of the feature either explicitly or implicitly. In the description of the present disclosure, the meaning of “a plurality” is at least two, for example, two, three, and the like, unless specifically defined otherwise.

In the present disclosure, the descriptions of “one embodiment”, “some embodiments” or the like described in the specification mean that one or more embodiments of the present disclosure can include particular features, structures, or characteristics which are related to the descriptions of the descripted embodiments. Therefore, the sentences “in one embodiment”, “in some embodiments”, “in other embodiments”, “in other embodiments” and the like that appear in different places of the specification do not mean that descripted embodiments should be referred by all other embodiments, but instead be referred by “one or more but not all other embodiments” unless otherwise specifically emphasized.

The present disclosure relates to navigation of a mobile machine. As used herein, the term “mobile machine” refers to a machine such as a mobile robot or a vehicle that has the capability to move around in its environment. The term “navigation” refers to the process of monitoring and controlling the movement of a mobile machine from one place to another. The term “surface profile” refers to the features of a surface or terrain that distinguish them from one another, such as surface texture, topography, roughness or a combination of them. For example, the surface profile of a hardwood floor could consist of the smoothness, roughness and texture.

The term “surface profile classifier” refers to the classifier of surface profiles, which is implemented through an artificial neural network that outputs information of the surface profiles according to the input data. The term “sensor” refers to a device, module, machine, or subsystem such as ambient light sensor and image sensor (e.g., camera) whose purpose is to detect events or changes in its environment and send the information to other electronics (e.g., processor). The term “accelerometer” refers to a device (e.g., micro-electro-mechanical systems (MEMS) accelerometer) that measures the proper acceleration of an object such as a mobile machine. The term “path planning” refers to find a sequence of valid configurations that moves a mobile machine from the source to the goal point, where “path” denotes a set of states (position and/or orientation) or waypoints without time stamp (cf. “trajectory” denotes a set of states or waypoints with time stamp). The term “collision avoidance” refers to prevent or reduce the severity of a collision.

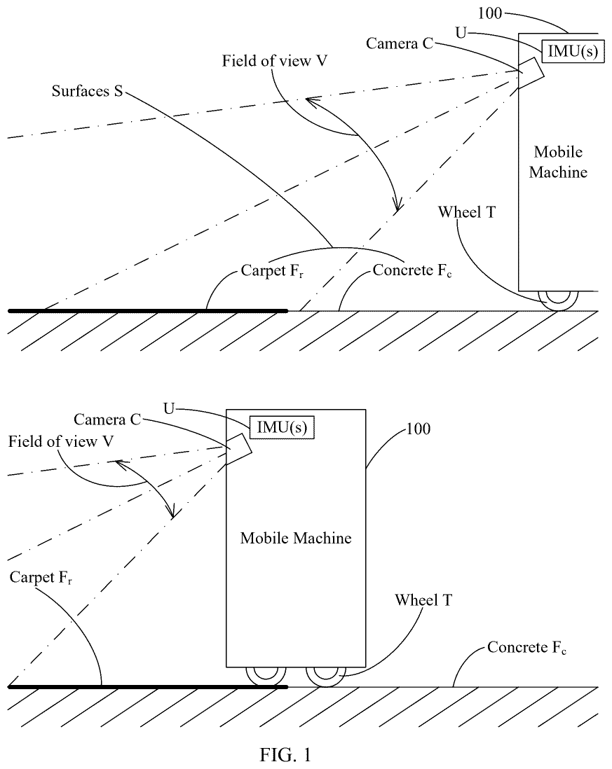

FIG. 1 is a schematic diagram of a scenario of navigating a mobile machine 100 (e.g., a cleaning robot) across different floor types according to some embodiments of the present disclosure. In the scenario (e.g., home, nursing home, or hospital) in which the mobile machine 100 being an autonomous mobile robot such as a service robot is navigated around to perform various tasks like housework, health care, medical care, object delivery, mobility aid, and guest greeting, the mobile machine 100 often needs to move across various types of surfaces S (i.e., the surfaces of concrete F_{c} and carpet Fᵣ) of a floor, ground, path, or the like. For the safety of the mobile machine 100 itself and the people, animals, and objects around, in addition to avoiding dangerous situations like collisions and falling, it is also necessary to prevent its movement from being affected, for example, obstructed, decelerated, tripped, or slipped.

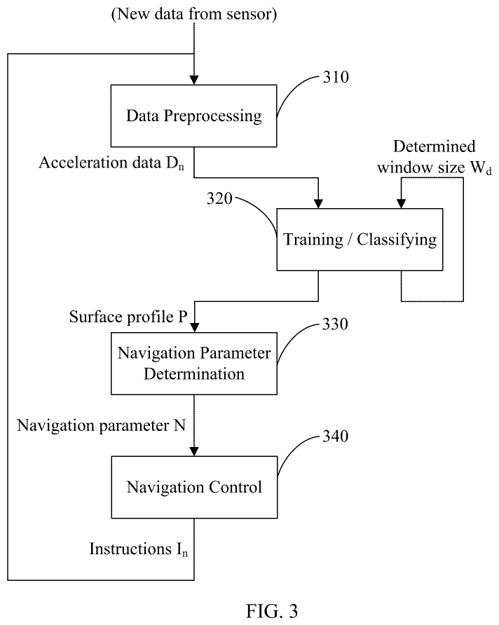

In some embodiments, in order to navigate as demand, the mobile machine 100 may have wheels T for moving on (the surface S of) the floor, ground, path, or the like, a camera C for detecting the environment around to facilitate navigations, and inertial measurement unit(s) (IMU) U for detecting the motions of the mobile machine 100 (by measuring acceleration and rotational speed of the motions) to monitor the navigations. As an example, as the upper part of FIG. 1 shows, when encountering an unknown environment that is required to move over the surface S not familiar with, similar to a human tends to look for visual cues at first instance, the mobile machine 100 may first use the camera C to capture images of a field of view V in its front, and analysis the captured images to recognize the types of (the surfaces S of) the floor, ground, path, or the like (i.e., the concrete F_{c} near and the carpet Fᵣ in the distance) within the field of view V where the mobile machine 100 could be moved onto in a few seconds. Although it is common to use the camera C to detect road conditions and hazards (e.g., water spits), it is computationally expensive and can be faulty—even if the mobile machine 100 recognizes something, it does not mean it is what it looks like. For instance, a carpet with stone patterns is a carpet, and not a terrain with stones as registered by the camera C. Therefore, it can be mistaken if only using the camera C. To solve this drawback, as the lower part of FIG. 1 shows, after recognizing the carpet Fᵣ through the camera C, similar to a human tends to step on the surface S not familiar with and register the “feeling”, when the mobile machine 100 is moved onto the carpet Fᵣ, that is, the wheel(s) T get on to the carpet Fᵣ, the mobile machine 100 may perform a navigation method (see FIG. 3) to register acceleration data Dₙ (see FIG. 3) received from the IMU U for a short period of time (e.g., fraction of a second) and truly determine the type of (the surface S of) the floor, ground, path, or the like (i.e., the carpet Fᵣ) it is moving on.

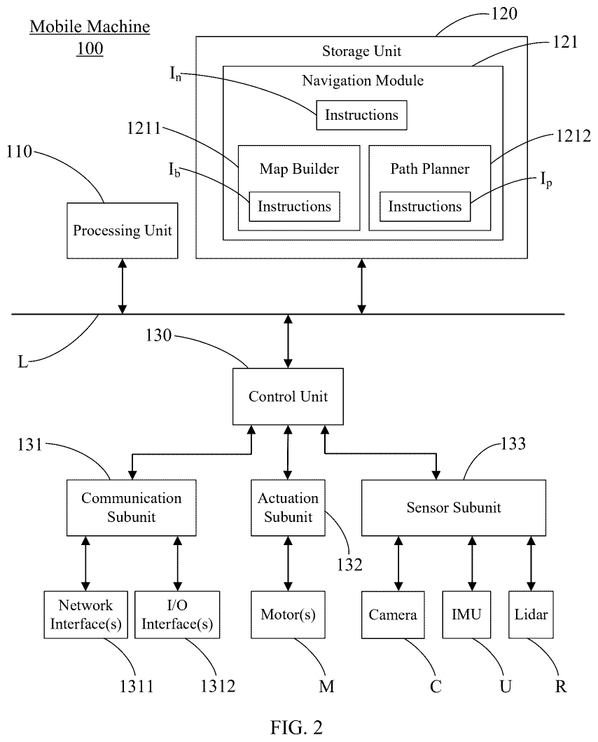

FIG. 2 is a schematic block diagram illustrating the mobile machine 100 of FIG. 1. The mobile machine 100 may be a mobile robot such as a wheeled robot, which may include a processing unit 110, a storage unit 120, and a control unit 130 that communicate over one or more communication buses or signal lines L. It should be noted that, the mobile machine 100 is only one example of mobile machine, and the mobile machine 100 may have more or fewer components (e.g., unit, subunits, and modules) than shown in above or below, may combine two or more components, or may have a different configuration or arrangement of the components. The processing unit 110 executes various (sets of) instructions stored in the storage unit 120 that may be in form of software programs to perform various functions for the mobile machine 100 and to process related data, which may include one or more processors (e.g., CPU). The storage unit 120 may include one or more memories (e.g., high-speed random access memory (RAM) and non-transitory memory), one or more memory controllers, and one or more non-transitory computer readable storage mediums (e.g., solid-state drive (SSD) or hard disk drive). The control unit 130 may include various controllers (e.g., camera controller, display controller, and physical button controller) and peripherals interface for coupling the input and output peripheral of the mobile machine 100, for example, external port (e.g., USB), wireless communication circuit (e.g., RF communication circuit), audio circuit (e.g., speaker circuit), sensor (e.g., the IMU), and the like, to the processing unit 110 and the storage unit 120. In some embodiments, the storage unit 120 may include a navigation module 121 for implementing navigation functions (e.g., map building and path planning) related to the navigation (and path planning) of the mobile machine 100, which may be stored in the one or more memories (and the one or more non-transitory computer readable storage mediums). In other embodiments, the mobile machine 100 may be a vehicle such as a car, a drone, or a vessel.

The navigation module 121 in the storage unit 120 of the mobile machine 100 may be a software module (of the operation system of the mobile machine 100), which has instructions IL (e.g., instruction for actuating motor(s) M of the mobile machine 100 to move the mobile machine 100) for implementing the navigation of the mobile machine 100, a map builder 1211, and path planner(s) 1212. The map builder 1211 may be a software module having instructions I_{b} for building map for the mobile machine 100. The path planner(s) 1212 may be software module(s) having instructions Ip for planning path for the mobile machine 100. The path planner(s) 1212 may include a global path planner for planning global paths for the mobile machine 100 and a local path planner for planning local paths for the mobile machine 100. The global path planner may be, for example, a path planner which plans global paths based on map(s) built by the map builder 1211 through, for example, SLAM. The local path planner may be, for example, a path planner based on A*, RRT* (rapidly-exploring random trees), or TEB (timed elastic band) algorithm, which plans local paths based on the global paths, and other data collected by the mobile machine 100. For example, images may be collected through the camera C and/or a lidar R of the mobile machine 100, and the collected images may be analyzed so as to identify obstacles, so that the local path can be planned with reference to the identified obstacles, and the obstacles can be avoided by moving the mobile machine 100 according to the planned local path. In other embodiments, rather than including the global path planner and the local path planner, the path planner(s) 1212 may include a path planner for planning both the global paths and the local paths.

Each of the map builder 1211 and the path planner(s) 1212 may be a submodule separated from the instructions Iₙ or other submodules of the navigation module 121, or a part of the instructions Iₙ for implementing the navigation of the mobile machine 100. The path planner(s) 1212 may further have data (e.g., input/output data and temporary data) related to the path planning of the mobile machine 100 which may be stored in the one or more memories and accessed by the processing unit 110. In some embodiments, each of the path planner(s) 1212 may be a module in the storage unit 120 that is separated from the navigation module 121.

In some embodiments, the instructions Iₙ may include instructions for implementing collision avoidance of the mobile machine 100 (e.g., obstacle detection and path replanning). In addition, the local path planner may plan a detour path to graft to the global path(s) in response to, for example, the original global path(s) being blocked (e.g., blocked by an unexpected obstacle) or inadequate for collision avoidance (e.g., impossible to avoid a detected obstacle when adopted) (the detour path is grafted to the global path(s) by replacing a part of the original global path(s) that is near to the obstacle). In other embodiments, the navigation module 121 may be a navigation unit communicating with the processing unit 110, the storage unit 120, and the control unit 130 over the one or more communication buses or signal lines L, and may further include one or more memories (e.g., high-speed random access memory (RAM) and non-transitory memory) for storing the instructions In, the map builder 1211, and the path planner(s) 1212, and one or more processors (e.g., MPU and MCU) for executing the stored instructions Iₙ, I_{b} and Iₚ to implement the navigation of the mobile machine 100.

The mobile machine 100 may further include a communication subunit 131 and an actuation subunit 132. The communication subunit 131 and the actuation subunit 132 communicate with the control unit 130 over one or more communication buses or signal lines that may be the same or at least partially different from the above-mentioned one or more communication buses or signal lines L. The communication subunit 131 is coupled to communication interfaces of the mobile machine 100, for example, network interface(s) 1311 for the mobile machine 100 to communicate with a control device via network(s) and I/O interface(s) 1312 (e.g., a physical button), and the like. The actuation subunit 132 is coupled to component(s)/device(s) for implementing the motions of the mobile machine 100 by, for example, actuating the motor(s) M of the wheels T of the mobile machine 100. The communication subunit 131 may include controllers for the above-mentioned communication interfaces of the mobile machine 100, and the actuation subunit 132 may include controller(s) for the above-mentioned component(s)/device(s) for implementing the motions of the mobile machine 100. In other embodiments, the communication subunit 131 and/or actuation subunit 132 may just abstract component for representing the logical relationships between the components of the mobile machine 100.

The mobile machine 100 may further include a sensor subunit 133 which may include a set of sensor(s) and related controller(s), for example, the camera C and the IMU U (or an accelerometer and a gyroscope), for detecting the environment in which it is located to realize its navigation. The sensor subunit 133 communicates with the control unit 130 over one or more communication buses or signal lines that may be the same or at least partially different from the above-mentioned one or more communication buses or signal lines L. In other embodiments, in the case that the navigation module 121 is the above-mentioned navigation unit, the sensor subunit 133 may communicate with the navigation unit over one or more communication buses or signal lines that may be the same or at least partially different from the above-mentioned one or more communication buses or signal lines L. In addition, the sensor subunit 133 may just abstract component for representing the logical relationships between the components of the mobile machine 100.

In some embodiments, the map builder 1211, the path planner(s) 1212, the sensor subunit 133, and the motor(s) M (and the wheels T of the mobile machine 100 coupled to the motor(s) M) jointly compose a (navigation) system which implements map building, (global and local) path planning, and motor actuating so as to realize the navigation of the mobile machine 100. In addition, the various components shown in FIG. 2 may be implemented in hardware, software or a combination of both hardware and software. Two or more of the processing unit 110, the storage unit 120, the control unit 130, the navigation module 121, and other units/subunits/modules may be implemented on a single chip or a circuit. In other embodiments, at least a part of them may be implemented on separate chips or circuits.

FIG. 3 is a schematic block diagram of an example of navigating the mobile machine 100 of FIG. 2. In some embodiments, the above-mentioned navigation method is implemented in the mobile machine 100, which navigates the mobile machine 100 on (the surface S of) a floor, ground, path, or the like per a surface profile P of the surface S that is determined through a surface profile classifier E (not shown) by, for example, storing (sets of) instructions corresponding to the navigation method (e.g., instructions for controlling the motor M(s)) as the navigation module 121 in the storage unit 120 while storing data (e.g., the acceleration data Dₙ, the surface profile classifier E, and the surface profile P) related to the navigation method in the storage unit 120, and executing the stored instructions through the processing unit 110, so that the mobile machine 100 is controlled accordingly. The navigation method may be performed in response to actuating the mobile machine 100 through, for example, physical button(s) or a remote control of the mobile machine 100. In other embodiments, the navigation method may also be performed in response to a request from, for example, (the operation system of) the mobile machine 100. According to the navigation method, during the mobile machine 100 is navigated to move on the surface S (e.g., the concrete F_{c} or the carpet Fᵣ) of the floor, ground, path, or the like, the processing unit 110 may receive data from sensor(s) (e.g., the IMU U) of the mobile machine 100, then preprocess the received data to provide the acceleration data Dₙ (block 310 of FIG. 3).

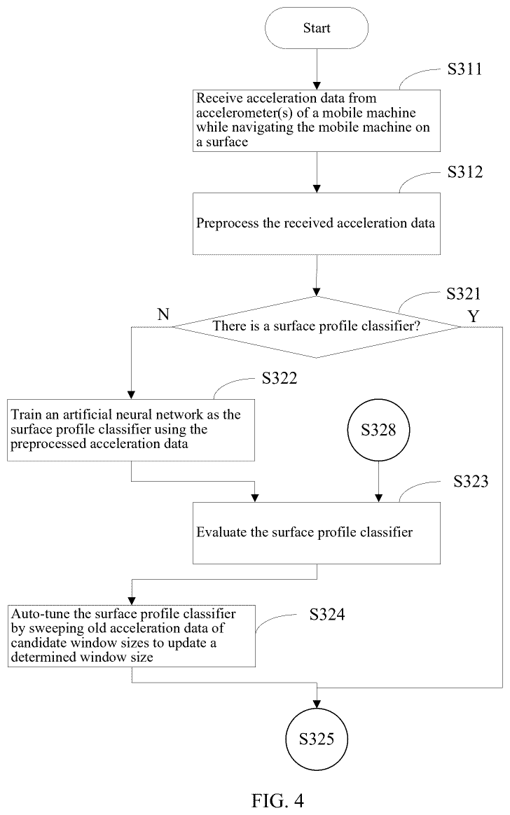

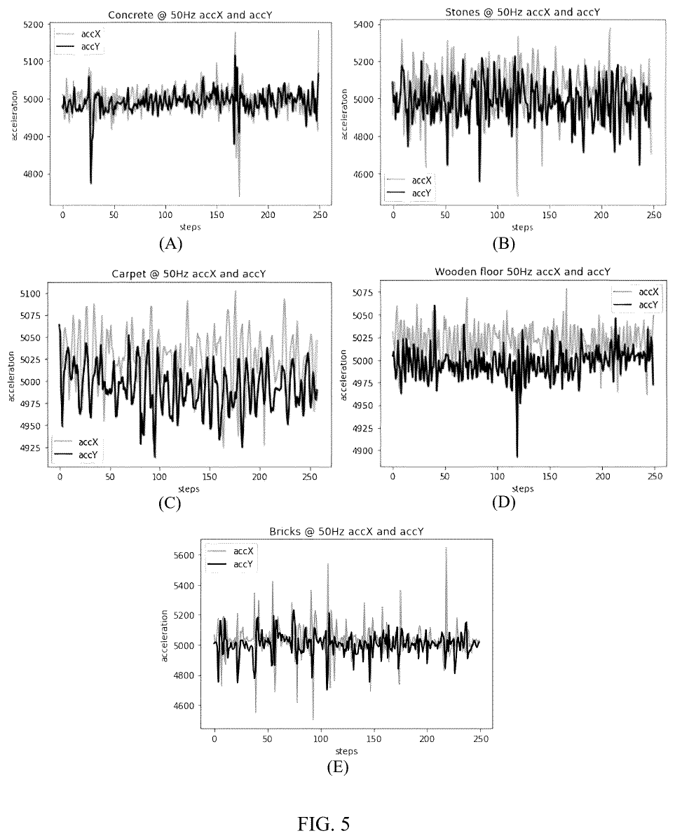

FIG. 4 is a flow chart of an example of preprocessing the acceleration data Dₙ and training the surface profile classifier E according to some embodiments of the present disclosure. Accordingly, at step S311, in some embodiments, while the mobile machine 100 is navigated on the surface S, the acceleration data Dₙ is directly received from accelerometer(s). The IMU U is used as the accelerometer(s), and the newly received acceleration data Dₙ may be stored in the storage unit 120 as a data set of sequential data points. FIG. 5 is a schematic diagram of accelerations from moving over different surfaces S according to some embodiments of the present disclosure. Y-axis represents the acceleration in x and y directions, while X-axis represents the steps in experiments. Specifically, Y-axis is the axis of the acceleration of the mobile machine 100 when it's moving, and X-axis is the axis of the distance the mobile machine 100 has traveled. As shown in FIG. 5, when the mobile machine 100 is moving at a constant velocity of 1 m/s, the surface S of concrete (part (A)) has smaller accelerations than that of stones (part (B)), which may be because of its smoother surface; the surface S of carpet (part (C)) and that of wooden floor (part (D)) both have different accelerations in the X-axis and the Y-axis, which may be because of their surface textures that cause different resistances in the forward and backward directions and the leftward and rightward directions of the mobile machine 100; and the surface S of bricks has intermittent larger accelerations, which may be caused by the interval between different bricks.

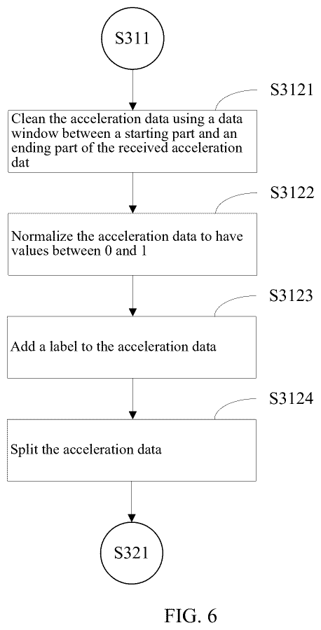

As shown in FIG. 4, at step S312, the received acceleration data Dₙ is preprocessed. The acceleration data Dₙ output by the IMU U is raw data that needs to be preprocessed to facilitate the subsequent step of classifier training (see step S322) in the navigation method. FIG. 6 is a flow chart of an example of preprocessing the acceleration data Dₙ in the example of FIG. 4. In some embodiments, the preprocess of the acceleration data Dₙ may include cleaning (step S3121), regularization (step S3121), labelling (step S3123), and splitting (step S3124). At step S3121, the newly received acceleration data Dₙ may be cleaned by selecting a data window between a starting part and an ending part of the received acceleration data Dₙ. For example, when the mobile machine 100 is moving at a constant velocity, the raw data, that is, the newly received, un-preprocessed acceleration data Dₙ may be cleaned by selecting the stable data window (which corresponds to, for example, 250 data points in the received acceleration data Dₙ, or the data points collected within 5 seconds) that represents a distinctive pattern (i.e., surface texture) of the surface S to remove, from the raw data, the data points in the starting part of the raw data (i.e., the initial data points such as the first 50 data points or the data points collected in the first 1 second) and that in the ending part of the raw data (i.e., the final data points such as the data points after that of the selected data window), since the initial and final data points in the raw data may not represent the meaningful pattern of the surface S. The raw data may be further cleaned by, for example, removing or handling missing data (e.g., imputing using techniques like mean, median, or interpolation), or by detecting and handling outlier (e.g., removing or transforming using techniques like winsorization or truncation).

At step S3122, the acceleration data Dₙ may be normalized to have values between 0 and 1. In some embodiments, considering that the acceleration data Dₙ to be used in the subsequent steps including classifier training (see step S322) in the navigation method that trains an artificial neural network A (not shown) is required to be as stable as possible without peaks or patterns not representing the surface S, and the artificial neural network A will also work more efficiently with data values between 0 and 1, the acceleration data Dₙ may be regularized to have a maximum value (i.e., the top limit) of 1 and a minimum value (i.e., the lower limit) of 0. In other embodiments, to prevent certain features from dominating the training process of the artificial neural network A, the received acceleration data Dₙ may instead be normalized by rescaling numerical features to a similar range, or by normalizing categorical features to convert categorical variables into numerical representations such as one-hot encoding or label encoding. At step S3123, a label may be added to the acceleration data Dₙ. In some embodiments, the label may be associated with the corresponding data points of the acceleration data Dₙ by adding an extra column to the above-mentioned data set of sequential data points where each row corresponds to the label for the respective data point. For example, 0 may be the label for wooden floor, 1 may be the label for carpet, 2 may be the label for concrete, and 3 may be the label for stones. At step S3124, the acceleration data Dₙ may be split. In some embodiments, the acceleration data Dₙ may be split into a training set used to train the artificial neural network A, a validation set used to tune hyperparameters and monitor performance during training the artificial neural network A, and a testing set used to evaluate the performance of the trained artificial neural network A, where the ratios of the training set, the validation set, and the testing set may be like 70:15:15, 80:10:10, or the like.

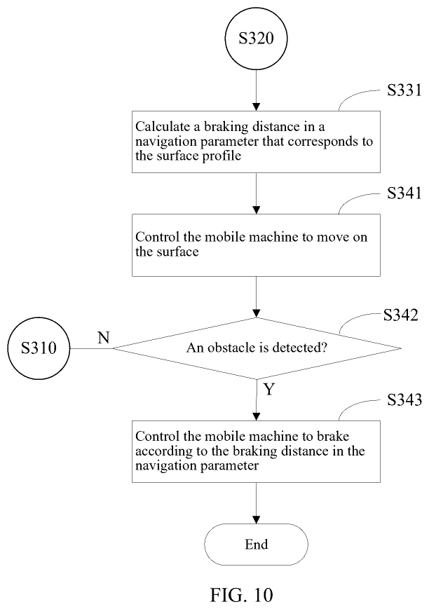

The processing unit 110 may further use the preprocessed acceleration data Dₙ to train the artificial neural network A (i.e., train/create the surface profile classifier E) and/or use the trained artificial neural network A (i.e., the trained/created surface profile classifier E) to classify the preprocessed acceleration data Dₙ to provide the recognized surface profile P, while update a determined window size Wd for the surface profile classifier E to recognize the surface profiles P in the best sampling frequency (block 320 of FIG. 3). For moving over the surface S not familiar with, similar to a human tends to carefully step on by analyzing the surface profiles P of the surface S with inertial sensing to determine the proper manner to walk on it, the mobile machine 100 may use the acceleration data Dₙ received from the IMU U to recognize the surface profile P of the surface S and determine corresponding navigation parameter(s) N to facilitate the subsequent step of navigation control (see step S341 of FIG. 10) in the navigation method. As shown in FIG. 4, at step S321, it determines whether the surface profile classifier E is created or not, that is, whether the artificial neural network A is trained or not. If yes, step S322 will be performed; otherwise, step S325 will be performed. The surface profile classifier E may be stored in the storage unit 120 and determined as having been created/trained if it can be found therefrom.

At step S322, the artificial neural network A is trained using the preprocessed acceleration data Dₙ to use as the surface profile classifier E. Before training, the artificial neural network A may be designed to choose the architecture, including the number of layers, the number of neurons in each layer, and the activation functions, and the loss function (e.g., categorical cross-entropy) and optimization algorithm (e.g., Adam or SGD) may be specified. Then, the artificial neural network A may be trained by inputting the above-mentioned training set of the preprocessed acceleration data Dₙ into the artificial neural network A and adjusting weights and biases of the artificial neural network A iteratively using backpropagation and an optimization algorithm to minimize the loss function. During training, the performance of the artificial neural network A may be monitored on the above-mentioned validation set to prevent overfitting by testing on the validation set. In some embodiments, the artificial neural network A (i.e., the surface profile classifier E) is a recurrent neural network (RNN). The artificial neural network A may be trained on a computer/server (e.g., the graphics processing unit (GPU) computer/server), and the well-trained artificial neural network A may be deployed on the machine 100 for inference/classifying the surface S. In other embodiments, the artificial neural network A may be a long short-term memory (LSTM). Since RNNs and LSTMs are designed to recognize patterns in sequences of data like numerical times series data from the IMU U, in contrast to classic artificial neural networks, the RNNs and LSTMs take time and sequence into account within a temporal dimension making them the most powerful and suitable artificial neural networks for classifying and learning surface profiles. At step S323, the surface profile classifier E is evaluated. After training, the performance of the artificial neural network A may be evaluated on the above-mentioned testing set to assess how well the artificial neural network A generalizes to unseen data by using evaluation metrics such as accuracy, precision, recall, and F1-score.

At step S324, the surface profile classifier E is auto-tuned by sweeping the old acceleration data Dₒ of a plurality of candidate window sizes W_{c} (not shown) of the surface profile classifier E to choose one of the candidate window sizes W_{c} to update the determined window size W_{d}. The old acceleration data Dₒ is the preprocessed acceleration data Dₙ previously received from the IMU U that had been used to train the artificial neural network A (i.e., the acceleration data to create the surface profile classifier E), which may have been stored in the storage unit 120. After training the artificial neural network A, the newly received acceleration data Dₙ will be input to the well-trained artificial neural network A for inference/classifying the surface S. In the sweeping, for each candidate window size, a window of that size is slid across (the above-mentioned training set of) the old acceleration data Dₒ to extract a subsequence, and the extracted subsequence is input into the surface profile classifier E for training. One of the candidate window sizes W_{c} that enables the surface profile classifier E to recognize the surface profiles P in the best sampling frequency will be chosen to update the determined window size W_{d}. In some embodiments, the candidate window sizes W_{c} of the surface profile classifier E may be from 2 to 32 data points, which means that the surface profile classifier E will try with only 2 data points at the beginning to classify all surface profiles P, then 3, 4, up to 32 data points.

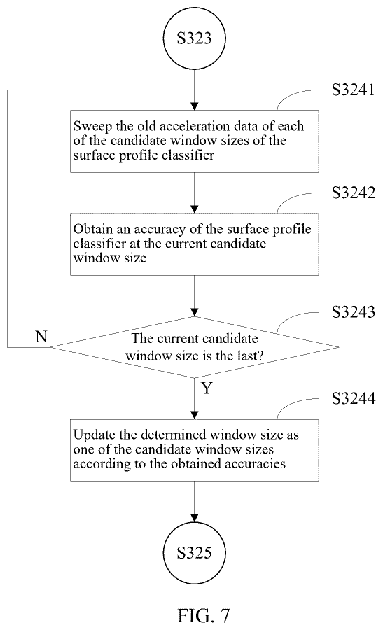

FIG. 7 is a flow chart of an example of auto-tunning the surface profile classifier E in the example of FIG. 4. At step S3241, old acceleration data Dₒ of each of the candidate window sizes W_{c} (e.g., from 2, 3 to 32 data points) of the surface profile classifier E is swept. In some embodiments, a helper function (e.g., get_{window size}) that has a window size variable may be created for sampling the old acceleration data Dₒ, and the old acceleration data Dₒ may be swept using the helper function by using each of the candidate window sizes (e.g., from 2, 3 to 32 data points) of the trained surface profile classifier E as the window size variable of the helper function. At step S3242, an accuracy of the surface profile classifier E at the current candidate window size W_{c} (i.e. the candidate window size W_{c} currently used for sweeping, e.g., 2, 3, or 32 data points) may be obtained. The accuracy may be obtained by, for example, defining the accuracy according to a confidence (e.g., confidence scores produced by the artificial neural network A) of the surface profile classifier E, or directly taking the confidence of the surface profile classifier E as the accuracy. At step S3243, it determines whether the current candidate window size W_{c} is the last candidate window size W_{c} (e.g., 32 data points) to be swept or not. If yes, step S3244 will be performed; otherwise, step S3241 will be reperformed. At step S3244, the determined window size W_{d} is updated as one of the candidate window sizes W_{c} according to the obtained accuracies.

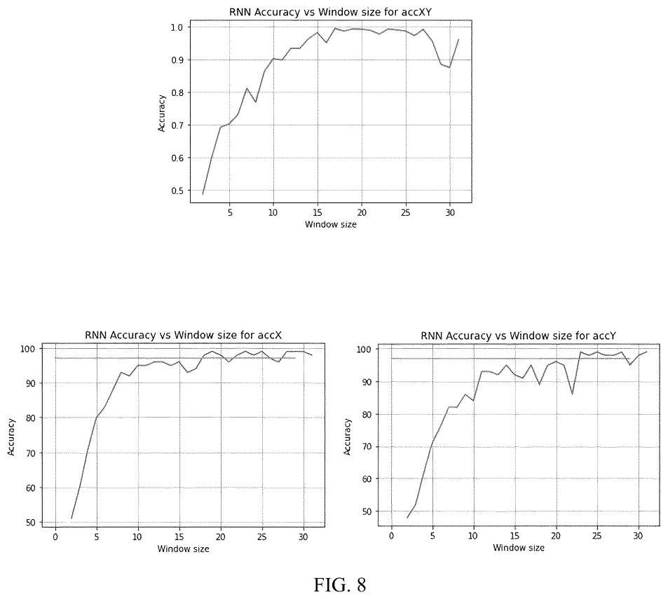

In some embodiments, the auto-tune may look for at least five consecutive window sizes with 97% accuracy to select the middle window size as the most reliable sampling for detecting any surface profile. The auto-tune may work with accelerations of single axis (i.e., X-axis or Y-axis), two axes (i.e., X-axis and the Y-axis), or more axes. FIG. 8 is a schematic diagram of auto-tunning the surface profile classifier E in the example of FIG. 4. As the upper part of FIG. 8 shows, in the case that the acceleration data Dₙ of two accelerometers of the IMU U on the X-axis and the Y-axis (which corresponds to the accelerations of both the X and Y-axes) are used, because the accuracy of the window size of 19 is greater than 97% while the window sizes of 17-21 have an accuracy of 97% or greater, the fastest and most reliable sampling for the surface profile classifier E will be at the window size of 19, where the accelerations of both the X and Y-axes are considered. Therefore, the determined window size W_{d} will be updated as the window size of 19. As the lower part of FIG. 8 shows, in the case that the acceleration data Dₙ of a single accelerometer of the IMU U on the X-axis (which corresponds to the accelerations of the X-axis) is used, the fastest and most reliable sampling for the surface profile classifier E will be at the window size of 24, where only the accelerations of the X-axis are considered; and in the case that the acceleration data Dₙ of a single accelerometer of the IMU U on the Y-axis (which corresponds to the accelerations of the Y-axis) is used, the fastest and most reliable sampling for the surface profile classifier E will be at the window size of 25, where only the accelerations of the Y-axis are considered. Therefore, the determined window size W_{d} will be updated as the window size of 24 when the acceleration data Dₙ of the accelerometer of the IMU U on the X-axis is used, and the determined window size W_{d} will be updated as the window size of 25 when the acceleration data Dₙ of the accelerometer of the IMU U on the Y-axis is used. After the auto-tunning, the determined window size W_{d} is updated by the best window size corresponding to the best sampling frequency for the surface profile classifier E to recognize any recognized surface profiles P stored in storage unit 120.

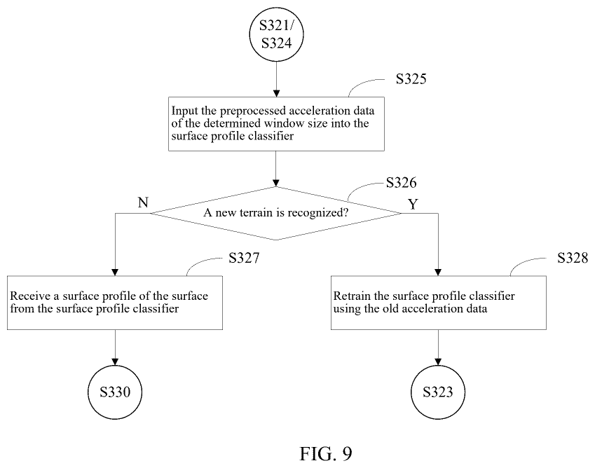

FIG. 9 is a flow chart of an example of retraining the surface profile classifier E and receiving the surface profile P according to some embodiments of the present disclosure. classifying surface profile. At step S325, the preprocessed acceleration data Dₙ of the determined window size W_{d} is input into the surface profile classifier E. After receiving the input preprocessed acceleration data Dₙ, the surface profile classifier E will sample the preprocessed acceleration data Dₙ with the window size equal to the determined window size W_{d}. In some embodiments, the determined window size W_{d} may be initially a predetermined value such as an experiential value, and then be updated as forgoing. In other embodiments, the determined window size W_{d} may be a predetermined fixed value, or be changed in other manners. At step S326, it determines whether a new terrain (which corresponds to a new, unrecognized surface profile P) is recognized or not. If no (i.e., no new terrain is recognized), step S327 will be performed; otherwise (i.e., the new terrain that does not correspond to any recognized surface profile P is recognized, which means learning the new terrain is needed), step S328 will be performed. In some embodiments, whether the new terrain is recognized or not may be determined according to the above-mentioned confidence of the surface profile classifier E for the preprocessed acceleration data Dₙ, which may be confidence-related information (e.g., the confidence scores, or outputs of Softmax function) produced by the artificial neural network A. For example, if the confidence is larger than or equal to a predetermined threshold, it may determine that no new terrain is recognized; otherwise, if the confidence is smaller than the predetermined threshold, it may determine that the new terrain is recognized.

At step S327, the surface profile P of the surface S is received from the surface profile classifier E. The surface profile classifier E classifies the input preprocessed acceleration data Dₙ to output the surface profile P (which has previously recognized and may have stored in the storage unit 120). In some embodiments, the surface profile P may be a data structure including information of the profile of the surface S, for example, surface texture, topography, roughness, or a combination of them. In other embodiments, the surface profile P may be merely a label, a name, a code, or the like for representing the corresponding surface profile. At step S328, the surface profile classifier E is retrained using the old acceleration data Dₒ. Then, step S323 will be (re)performed to evaluate the retrained surface profile classifier E, and step S324 will be (re)performed to auto-tune the retrained surface profile classifier E.

The processing unit 110 may further determine navigation parameter(s) N corresponding to the surface profile P (block 330 of FIG. 3) to navigate the mobile machine 100 according to the determined navigation parameter(s) N (block 340 of FIG. 3). The navigation parameter(s) N of the mobile machine 100 are dynamically adjusted according to the recognized surface profile P, so that the mobile machine 100 can be navigated accordingly. FIG. 10 is a flow chart of an example of navigating the mobile machine 100 of FIG. 2. In some embodiments, the navigation parameter(s) N may include a braking distance. At step S331, the braking distance in the navigation parameter(s) N that correspond to the surface profile S is calculated using an equation of.

d=v²/2ug;

where, d is the braking distance, v is the velocity of the mobile machine, u is a friction coefficient obtained based on the surface profile P (e.g., the friction coefficient obtained from the surface profile P and the rubber-like material on the wheels T of the mobile machine 100), and g is the gravitational acceleration constant (9.8 m/s²). The friction coefficient is determined through experimentation and testing, which may be measured by applying a known force to an object and measuring the resulting frictional force, using equipment such as a friction tester. At step S341, the mobile machine 100 is controlled to move on the surface S. At step S342, it determines whether an obstacle is detected or not. If yes, step S343 will be performed; otherwise, step S310 will be re-performed. At step S343, the mobile machine 100 is controlled to brake according to the braking distance in the determined navigation parameter(s) N. In other embodiments, the navigation parameter(s) N may include an acceleration profile. For example, a model predictive controller foresees the future for a finite time horizon using a mathematical model of the mobile machine 100, and the control inputs require the acceleration profile. Correspondingly, it may determine the acceleration profile according to the surface profile P, and control the mobile machine 100 to move according to the acceleration profile in the determined navigation parameter(s) N.

The navigation method uses acceleration data received from accelerometers to recognize the surface profile and navigates the mobile machine by dynamically adjusting the navigation parameters according to the recognized surface profile, miming the behaviors of a human who carefully steps on unfamiliar terrain and enhancing the efficiency and safety of movements. In addition, the navigation method is cheaper in computation and cost, because the acceleration data from the accelerometers like the IMUs that are embedded in almost all mobile machines is used, compared with images from camera or point cloud data from lidar.

It can be understood by those skilled in the art that, all or part of the method in the above-mentioned embodiment(s) can be implemented by one or more computer programs to instruct related hardware. In addition, the one or more programs can be stored in a non-transitory computer readable storage medium. When the one or more programs are executed, all or part of the corresponding method in the above-mentioned embodiment(s) is performed. Any reference to a storage, a memory, a database or other medium may include non-transitory and/or transitory memory. Non-transitory memory may include read only memory (ROM), programmable ROM (PROM), electrically programmable ROM (EPROM), electrically erasable programmable ROM (EEPROM), flash memory, solid-state drive (SSD), or the like. Volatile memory may include random access memory (RAM), external cache memory, or the like.

The processing unit 110 (and the above-mentioned processor) may include central processing unit (CPU), or be other general purpose processor, GPU, digital signal processor (DSP), application specific integrated circuit (ASIC), field-programmable gate array (FPGA), or be other programmable logic device, discrete gate, transistor logic device, and discrete hardware component. The general purpose processor may be microprocessor, or the processor may also be any conventional processor. The storage unit 120 (and the above-mentioned memory) may include internal storage unit such as hard disk and internal memory. The storage unit 120 may also include external storage device such as plug-in hard disk, smart media card (SMC), secure digital (SD) card, and flash card.

The exemplificative units/modules and methods/steps described in the embodiments may be implemented through software, hardware, or a combination of software and hardware. Whether these functions are implemented through software or hardware depends on the specific application and design constraints of the technical schemes. The above-mentioned path planning method and mobile machine may be implemented in other manners. For example, the division of units/modules is merely a logical functional division, and other division manner may be used in actual implementations, that is, multiple units/modules may be combined or be integrated into another system, or some of the features may be ignored or not performed. In addition, the above-mentioned mutual coupling/connection may be direct coupling/connection or communication connection, and may also be indirect coupling/connection or communication connection through some interfaces/devices, and may also be electrical, mechanical or in other forms.

The above-mentioned embodiments are merely intended for describing but not for limiting the technical schemes of the present disclosure. Although the present disclosure is described in detail with reference to the above-mentioned embodiments, the technical schemes in each of the above-mentioned embodiments may still be modified, or some of the technical features may be equivalently replaced, so that these modifications or replacements do not make the essence of the corresponding technical schemes depart from the spirit and scope of the technical schemes of each of the embodiments of the present disclosure, and should be included within the scope of the present disclosure.

What is claimed is:

1. A method for navigating a mobile machine having at least an accelerometer on a surface, comprising:
receiving, from the accelerometer of the mobile machine, acceleration data while navigating the mobile machine on the surface;
inputting the received acceleration data of a determined window size into an artificial neural network-based surface profile classifier;
receiving a surface profile of the surface from the surface profile classifier;
determining at least a navigation parameter corresponding to the surface profile; and
navigating the mobile machine according to the determined navigation parameter.

2. The method of claim 1, wherein the surface profile classifier is implemented as a recurrent neural network; before inputting the received acceleration data into the artificial neural network-based surface profile classifier, the method further comprises:
preprocessing the received acceleration data;
training the surface profile classifier using the preprocessed acceleration data; and
auto-tunning the trained surface profile classifier by sweeping old acceleration data of a plurality of candidate window sizes of the trained surface profile classifier to choose the candidate window size for updating the determined window size, wherein the old acceleration data is the preprocessed acceleration data previously received from the accelerometer that had been used to train the trained surface profile classifier.

3. The method of claim 2, wherein preprocessing the acceleration data comprises:
cleaning the received acceleration data by selecting a data window between a starting part of the received acceleration data and an ending part of the received acceleration data.

4. The method of claim 3, wherein preprocessing the acceleration data further comprises:
normalizing all the received acceleration data to have values between 0 and 1; and
adding a label to the acceleration data.

5. The method of claim 2, wherein after inputting the received acceleration data into the artificial neural network-based surface profile classifier, the method further comprises:
obtaining a confidence of the surface profile classifier for the preprocessed acceleration data;
receiving the surface profile of the surface from the surface profile classifier comprises:
receiving the surface profile of the surface from the surface profile classifier in response to the confidence being not smaller than a predetermined threshold; and
training the surface profile classifier using the preprocessed acceleration data comprises:
training the surface profile classifier using the preprocessed acceleration data in response to the confidence being smaller than the predetermined threshold.

6. The method of claim 2, wherein the received acceleration data is received after the old acceleration data while navigating the mobile machine on the surface; training the surface profile classifier using the preprocessed acceleration data comprises:
retraining the surface profile classifier using the old acceleration data; and
sweeping the old acceleration data of the candidate window sizes of the trained surface profile classifier to choose the candidate window size for updating the determined window size comprises:
sweeping the old acceleration data of the candidate window sizes of the trained surface profile classifier to choose the candidate window size for updating the determined window size.

7. The method of claim 2, wherein sweeping the old acceleration data of the candidate window sizes of the trained surface profile classifier to choose the candidate window size for updating the determined window size comprises:
sweeping the old acceleration data of each of the candidate window sizes of the trained surface profile classifier;
obtaining an accuracy of the surface profile classifier at the candidate window size; and
updating the determined window size as the candidate window size corresponding to the highest accuracy.

8. The method of claim 7, wherein sweeping the old acceleration data of each of the candidate window sizes of the trained surface profile classifier comprise:
creating a helper function for sampling the preprocessed acceleration data, wherein the helper function has a window size variable; and
sweeping the old acceleration data using the helper function by using each of the candidate window sizes of the trained surface profile classifier as the window size variable of the helper function.

9. The method of claim 1, wherein the candidate window sizes of the trained surface profile classifier are from 2 to 32 data points.

10. The method of claim 9, wherein the determined window size is 24 when the acceleration data is received from the accelerometer correspond to an X-axis, and the determined window size is 25 when the acceleration data is received from the accelerometer correspond to a Y-axis.

11. The method of claim 9, wherein the determined window size is 19 when the acceleration data is received from two accelerometers each corresponding to an X-axis and a Y-axis.

12. The method of claim 1, wherein the navigation parameter includes a braking distance; determining the navigation parameter corresponding to the surface profile comprises:
calculating the braking distance corresponding to the surface profile using an equation of:
d=v²/2ug;
where, d is the braking distance, v is the velocity of the mobile machine, u is a friction coefficient obtained based on the surface profile, and g is the gravitational acceleration constant; and
navigating the mobile machine according to the determined navigation parameter comprises:
detecting an obstacle while navigating the mobile machine on the surface; and
controlling the mobile machine to brake according to the braking distance in the determined navigation parameter in response to having detected the obstacle.

13. The method of claim 1, wherein the navigation parameter includes an acceleration profile; determining the navigation parameter corresponding to the surface profile comprises:
determining the acceleration profile according to the surface profile;
navigating the mobile machine according to the determined navigation parameter comprises:
controlling the mobile machine to move according to the acceleration profile in the determined navigation parameter.

14. A mobile machine, comprising:
at least an accelerometer;
one or more processors; and
one or more memories storing one or more programs configured to be executed by the one or more processors, wherein the one or more programs comprise instructions to:
receive acceleration data from the accelerometer while navigating the mobile machine on the surface;
input the received acceleration data of a determined window size into an artificial neural network-based surface profile classifier;
receive a surface profile of the surface from the surface profile classifier;
determine at least a navigation parameter corresponding to the surface profile; and
navigate the mobile machine according to the determined navigation parameter

15. The mobile machine of claim 14, wherein the surface profile classifier is implemented as a recurrent neural network; before inputting the received acceleration data into the artificial neural network-based surface profile classifier, the method further comprises:
preprocessing the received acceleration data;
training the surface profile classifier using the preprocessed acceleration data; and
auto-tunning the trained surface profile classifier by sweeping old acceleration data of a plurality of candidate window sizes of the trained surface profile classifier to choose the candidate window size for updating the determined window size, wherein the old acceleration data is the preprocessed acceleration data previously received from the accelerometer that had been used to train the trained surface profile classifier.

16. The mobile machine of claim 15, wherein preprocessing the acceleration data comprises:
cleaning the received acceleration data by selecting a data window between a starting part of the received acceleration data and an ending part of the received acceleration data.

17. The mobile machine of claim 16, wherein preprocessing the acceleration data further comprises:
normalizing all the received acceleration data to have values between 0 and 1; and
adding a label to the acceleration data.

18. The mobile machine of claim 15, wherein the received acceleration data is received after the old acceleration data while navigating the mobile machine on the surface;
training the surface profile classifier using the preprocessed acceleration data comprises:
retraining the surface profile classifier using the old acceleration data; and
sweeping the old acceleration data of the candidate window sizes of the trained surface profile classifier to choose the candidate window size for updating the determined window size comprises:
sweeping the old acceleration data of the candidate window sizes of the trained surface profile classifier to choose the candidate window size for updating the determined window size.

19. The mobile machine of claim 15, wherein sweeping the old acceleration data of the candidate window sizes of the trained surface profile classifier to choose the candidate window size for updating the determined window size comprises:
sweeping the old acceleration data of each of the candidate window sizes of the trained surface profile classifier;
obtaining an accuracy of the surface profile classifier at the candidate window size; and
updating the determined window size as the candidate window size corresponding to the highest accuracy.

20. The mobile machine of claim 19, wherein sweeping the old acceleration data of each of the candidate window sizes of the trained surface profile classifier comprise:
creating a helper function for sampling the preprocessed acceleration data, wherein the helper function has a window size variable; and
sweeping the old acceleration data using the helper function by using each of the candidate window sizes of the trained surface profile classifier as the window size variable of the helper function.
